(19) United States
(12) Patent Application Publication
(10) Pub. No.: US 2025/0033325 A1
(43) Pub. Date: Jan. 30, 2025

(54) GLAZING WITH LIGHTING CAPABILITIES

(71) Applicant: ACR II GLASS AMERICA INC., Nashville, TN (US)

(72) Inventor: Markus Walter POHLEN, Grevenmacher (LU)

(21) Appl. No.: 18/716,434

(22) PCT Filed: Dec. 13, 2022
(86) PCT No.: PCT/US2022/081410

§ 371 Date: Jun. 4, 2024

Related U.S. Application Data
(60) Provisional application No. 63/289,360, filed on Dec. 14, 2021.

(51) Int. Cl. B32B 17/10; F21V 8/00

(52) U.S. Cl. CPC B32B 17/10541; B32B 17/10036; B32B 17/1011; B32B 17/10449; B32B 17/1088; G02B 6/005; B32B 2307/41; B32B 2605/00

(57) ABSTRACT

This disclosure relates to a glazing with a laminated structure for providing directed lighting capabilities that comprises a first glass sheet with a first surface and a second surface, a second glass sheet with a third surface and a fourth surface, an interlayer between the first glass sheet and the second glass sheet, and a lighting system, which may include a light source, a light guide attached to the first light source and at least partially laminated between the first glass sheet and the second glass sheet, and a light extraction zone having a light extraction means laminated between the first glass sheet and the second glass sheet.

### PRIORITY CLAIM AND CROSS-REFERENCE TO RELATED APPLICATIONS

This application claims priority to and benefit of U.S. Provisional Patent App. No. 63/289,360 filed Dec. 14, 2021, titled GLAZING WITH LIGHTING CAPABILITIES, the entire contents of which are incorporated by reference herein in their entirety and relied upon.

### BACKGROUND

The present disclosure is generally related to a glazing with lighting capabilities. There are numerous reasons an automotive vehicle may need to supply light to the interior or the exterior of the vehicle. For example, a rear windshield may be equipped with a rear brake light that emits light to the exterior of the vehicle whenever the brakes of the vehicle are engaged. Alternatively, lighting may be provided to the interior cabin of a vehicle to supply reading light or ambient lighting. Current vehicle cabin lighting systems may focus on providing large, centrally located cabin lights or overhead passenger lights that do not supply the desired light that some passengers require. Additionally, physical design constraints in automotive vehicles mean having the flexibility to supply the required light to the interior or exterior through different space efficient and aesthetically pleasing means is attractive.

For each of the above reasons, it is desirable to provide an automotive glazing with lighting capabilities for providing lighting for a vehicle.

### SUMMARY

The laminated glazing disclosed herein improves on existing glazing by providing a glazing with an integrated lighting system for providing light of a desired intensity to any desired location along the glazing.

In light of the disclosure, and without limiting the scope of the invention in any way, in a first aspect of the present disclosure, which may be combined with any other aspect listed herein unless specified otherwise, a glazing comprising a laminated structure including a first glass sheet with a first surface and second surface, a second glass sheet with a third surface and fourth surface, an interlayer between the first glass sheet and the second glass sheet, and a lighting system. The lighting system includes a light source and a light guide that is attached to the light source and at least partially laminated between the first glass sheet and the second glass sheet. The lighting system also includes a light extraction zone having a light extraction means laminated between the first glass sheet and the second glass sheet. The lighting system may provide a directed light for an interior or exterior of a vehicle

In a second aspect of the present disclosure, which may be combined with any other aspect listed herein unless specified otherwise, the interlayer is comprised of at least two separate layers.

In a third aspect of the present disclosure, which may be combined with any other aspect listed herein unless specified otherwise, the laminated portion of the light guide is positioned substantially along an opaque masking layer

In a fourth aspect of the present disclosure, which may be combined with any other aspect listed herein unless specified otherwise, an opaque masking layer is an enamel print

In a fifth aspect of the present disclosure, which may be combined with any other aspect listed herein unless specified otherwise, the glazing contains at least one additional lighting system.

In a sixth aspect of the present disclosure, which may be combined with any other aspect listed herein unless specified otherwise, the light extraction means includes a luminescent composition

In a seventh aspect of the present disclosure, which may be combined with any other aspect listed herein unless specified otherwise, the light guide is embedded into the interlayer.

In an eighth aspect of the present disclosure, which may be combined with any other aspect listed herein unless specified otherwise, the light guide is arranged around the periphery of the glazing.

In a ninth aspect of the present disclosure, which may be combined with any other aspect listed herein unless specified otherwise, the light guide extends out of at least one side the glazing.

In a tenth aspect of the present disclosure, which may be combined with any other aspect listed herein unless specified otherwise, the lighting system further comprises at least one lens positioned at the light extraction zone.

In an eleventh aspect of the present disclosure, which may be combined with any other aspect listed herein unless specified otherwise, the light source is a laser.

In a twelfth aspect of the present disclosure, which may be combined with any other aspect listed herein unless specified otherwise, wherein the light source attaches to the light guide via a fiber optic connector or an optical fiber coupler.

In a thirteenth aspect of the present disclosure, which may be combined with any other aspect listed herein unless specified otherwise, either the first glass sheet or the second glass sheet is darkened in color.

In a fourteenth aspect of the present disclosure, which may be combined with any other aspect listed herein unless specified otherwise, the glazing further comprises an infrared reflective layer.

In a fifteenth aspect of the present disclosure, which may be combined with any other aspect listed herein unless specified otherwise, the lighting system provides a reading light for a vehicle interior.

In a sixteenth aspect of the present disclosure, which may be combined with any other aspect listed herein unless specified otherwise, the lighting system provide a brake light to a vehicle exterior.

In a seventeenth aspect of the present disclosure, which may be combined with any other aspect listed herein unless specified otherwise, a method of preparing a glazing comprises aligning a lighting system including a light guide and a light extraction zone with a light extraction means throughout at least part of an interlayer and embedding the aligned lighting system in the interlayer. The method also includes laminating the interlayer between a first glass sheet and a second glass sheet so that the interlayer is in between the first glass sheet and second glass sheet.

In an eighteenth aspect of the present disclosure, which may be combined with any other aspect listed herein unless specified otherwise, the light guide of the lighting system is aligned such that it extends out of the glazing to attach to a light source.

In a nineteenth aspect of the present disclosure, which may be combined with any other aspect listed herein unless specified otherwise, the method further comprises providing an opaque masking layer on at least part of the interlayer, the first glass sheet, or the second glass sheet.

In a twentieth aspect of the present disclosure, which may be combined with any other aspect listed herein unless specified otherwise, the method further comprises attaching at least one lens to the surface of the second glass sheet at the light extraction zone

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

The accompanying drawings, which are incorporated into and constitute a part of this specification, illustrate one or more example aspects of the present disclosure and, together with the detailed description, serve to explain their principles and implementations.

FIG. 1 illustrates a cross section of a laminated glazing according to an exemplary embodiment of the present disclosure.

FIG. 2 illustrates a lighting system of a laminated glazing according to an exemplary embodiment of the present disclosure.

FIG. 3 illustrates a cross section of a laminated glazing according to an exemplary embodiment of the present disclosure.

FIG. 4 illustrates a cross section of a laminated glazing according to an exemplary embodiment of the present disclosure.

FIG. 5 is a block flowchart illustrating a method of preparing a laminated glazing according to an exemplary embodiment of the present disclosure.

### DETAILED DESCRIPTION

In the following description, for purposes of explanation, specific details are set forth in order to promote a thorough understanding of one or more aspects of the disclosure. It may be evident in some or all instances, however, that any aspects described below can be practiced without adopting the specific design details described below.

Among other features, the present disclosure provides an automotive glazing having lighting capabilities. A glazing comprises a laminated structure including a first glass sheet with a first surface and second surface, a second glass sheet with a third surface and fourth surface, an interlayer between the first glass sheet and the second glass sheet, and a lighting system. The lighting system includes a light source and a light guide that is attached to the light source and is at least partially laminated between the first glass sheet and the second glass sheet. The lighting system also includes a light extraction zone having a light extraction means laminated between the first glass sheet and the second glass sheet. For example, the lighting system of the automotive glazing may provide a reading light to a vehicle interior that may provide functional lighting strong enough to illuminate all or part of a cabin. Alternatively, the lighting system herein may further provide for an exterior light in a glazing, such as a brake light in a back window.

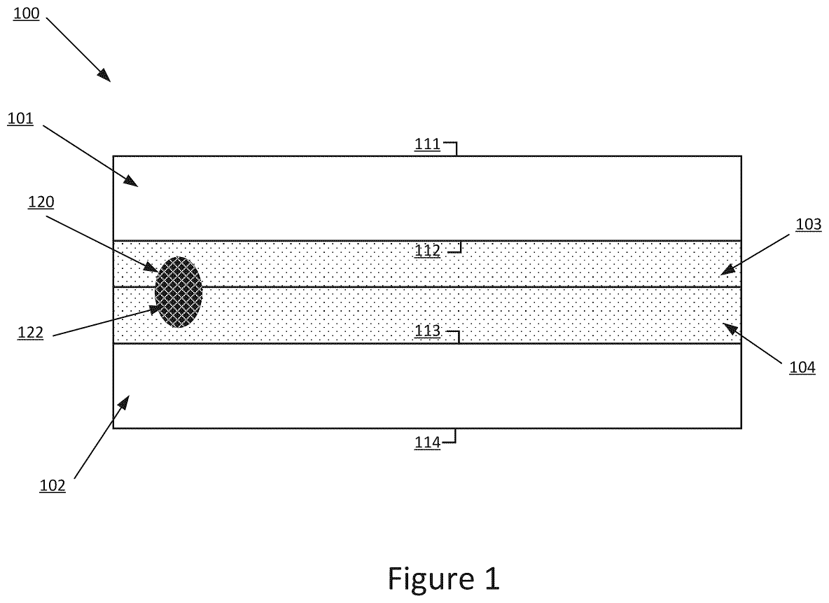

FIG. 1 illustrates a cross section of a laminated glazing according to an exemplary embodiment of the present disclosure. The glazing 100 may be a laminated structure including a first glass sheet 101 with a first surface 111 and second surface 112, a second glass sheet 102 with a third surface 113 and fourth surface 114. For example, the glazing 100 may be designed for use as a sunroof of a vehicle, where the first surface 111 of the first glass sheet 101 faces, such that it is exposed to, the exterior of the vehicle, the fourth surface 114 of the second glass sheet 102 faces the interior of the vehicle, and both the second surface 112 and third surface 113 face an interlayer 103, 104. The first and second glass sheets 101, 102 may preferably be from 0.5 mm to 3 mm, more preferably from 1 mm to 2.5 mm. The glass sheets 101, 102 may include, without limitation, soda-lime silicate glass described by ISO 16293-1:2008. The laminated structure of the glazing 100 may include an interlayer, which may contain one or more layers, such as a first interlayer 103 and a second interlayer 104. The interlayer is laminated between the second surface 112 of the first glass sheet 101 and the third surface 113 of the second glass sheet 102. The interlayer 103, 104 may include an adhesive polymer film, such as a polyvinyl butyral, or an ionomer. The laminated glazing may also include a lighting system 120 that features a light guide 122, for example for providing a cabin light in a vehicle. Particularly the lighting system may provide a directed light towards a vehicle exterior or a vehicle interior. A directed light towards a vehicle exterior may include a brake light positioned in a rear window. A directed light towards a vehicle interior may include a reading light or reading lights directed towards an interior passenger space.

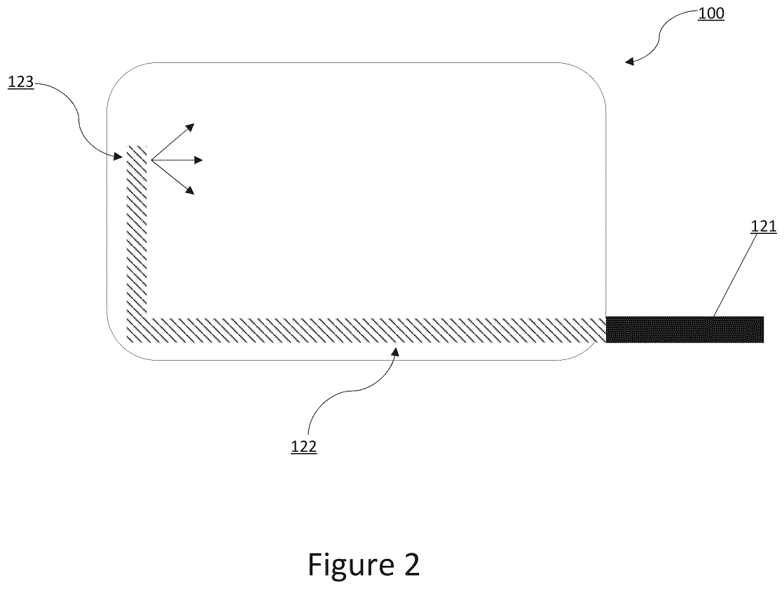

FIG. 2 illustrates an example lighting system of an embodiment of the present disclosure. A laminated glazing 100 according to an exemplary embodiment of the present disclosure may include a lighting system 120. A lighting system 120 for providing a light via a laminated glazing 100 may include a light source 121 attached to a light guide 122 and containing a light extraction zone 123. The light source 121 may be detachable from the light guide 122, coupled to each other for example by a fiber optic connector or optical fiber coupler. The light source 121 may preferably include a laser light source.

The light from the light source 121 may be directed to a light guide 122. The light may reflect within the light guide 122 with total internal reflection before reaching a light extraction zone 123. The light guide 122 may have an index of refraction higher than that of the surrounding materials. The light guide 122 may be thin and may be flexible so as to wrap around a laminated structure 100 periphery or arranged along the periphery of the laminated structure 100, as shown in FIG. 2. The light guide 122 may, for example, include a glass or polymer based optical fiber having a thickness of 0.1 to 1.5 mm.

The light guide 122 may extend out of the interlayers 103, 104 and the glazing 100 for attachment to a light source 121. Preferably, the light source 121 may be attached after lamination of the layers of the interlayer between first and second glass sheets 101, 102. In some embodiments, the first or second glass sheet 101, 102 may include a recess or an opening through which the optical fiber light guide 122 may pass.

The light guide 122 and light extraction zone 123 may be laminated between the first and second glass sheets 101, 102. The interlayer may include more than one layer (e.g. 103, 104) such that the light guide 122 and light extraction zone 123 may further be laminated between layers of the interlayer (for example, as shown in FIG. 1). In some embodiments, a third layer of the interlayer may be positioned around the light guide 122 and light extraction zone 123 so as to compensate for a thickness of the light guide 122.

The light guide 122 may include a light extraction zone 123, where light is emitted from the light guide into the laminated structure of the glazing 100. The light extraction zone 123 may be oriented such that the emitted light is directed towards the car exterior or towards the car interior, i.e. towards the first surface 111 and the fourth surface 114, respectively.

The light extraction zone 123 may include a light extraction means, which may include an area of the fiber light guide 122 having an extraction composition, such as a luminescent composition which may include luminescent particles or other luminescent material. A luminescent composition may include appropriate luminescent materials to extract the light in a desired visible wavelength. For example, the light may be extracted as white colored visible light. The intensity of the light may depend on the power supplied to the light source 121 in the lighting system 120. The power supplied to the light source 121 may be controlled by an electrically controlled driver unit. A user may be able to adjust the intensity of light with a dimming switch.

A glazing according to the present disclosure may include more than one lighting system. For example, a glazing 100 may be part of a rear windshield and include one lighting system with a first light source, first light guide, first light extraction zone, and first light extraction means configured to supply a brake light to the exterior of the vehicle. The same glazing may also include a second lighting system configured to supply ambient cabin lighting to the interior of the vehicle from a less powerful second light source, second light guide, second light extraction zone, and second light extraction means. In another example, a glass roof may include more than one lighting system. A reading light configured in a roof may include 2 lighting guides and light extraction means such that different light colors may be used. Some reading lights may have, for example, a cool light option or a warm light option for the user.

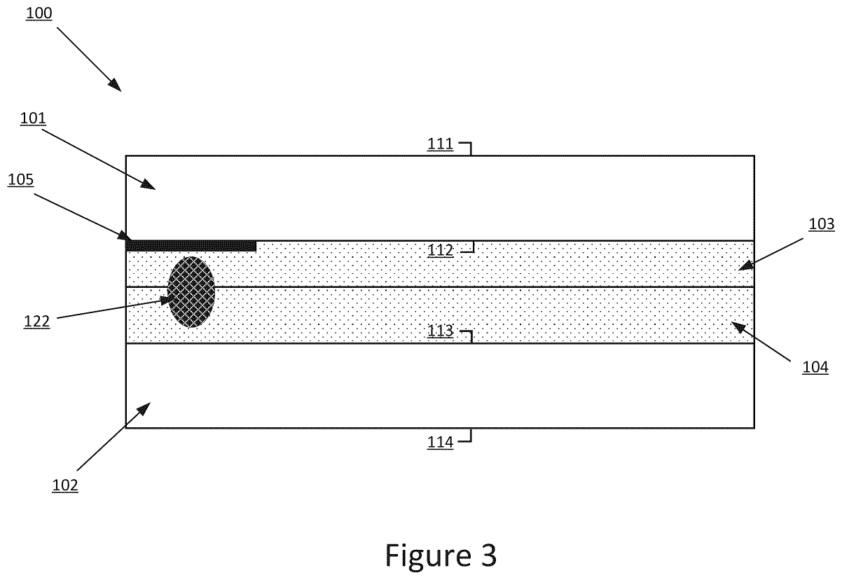

FIG. 3 illustrates a cross section of an example embodiment of a laminated glazing of the present disclosure. The light guide 122 and light extraction zone 123 may be positioned substantially along an area of the laminated structure of the glazing 100 having an opaque masking layer 105. The opaque masking layer 105 may include an opaque print around the periphery of the laminated structure of the glazing 100. Such an opaque print may be an enamel print, which may be black, and may be provided on a surface of the first glass sheet 101 and/or the second glass sheet 102. Where the light extraction zone 123 is aligned with the opaque masking layer 105 and the opaque masking layer 105 is positioned in the direction of desired lighting, the light extraction zone 123 may be directed at an angle, towards any area of the laminated glazing 100 without the opaque masking layer 105. In some embodiments, part of the light guide 122 and light extraction zone 123 may be visible in the glazing 100 and not aligned with the opaque masking layer 105. Where the light guide 122 and the light extraction zone 123 are visible, they may be positioned in a design or pattern. The light extraction zone 123 may be desired in a position separate from the opaque masking layer 105 and the lighting system 120 may extend from the opaque masking layer 105 to be positioned as desired.

The light guide 122 and light extraction zone 123 may be positioned within the glazing 100 such that the light extraction zone 123 is positioned for a desired function. For example, the light extraction zone 123 may be positioned at an area in the glazing 100 to provide a reading light near a passenger seat in a vehicle. In some embodiments, the glazing 100 may include a windshield having a light extraction zone 123 in an upper portion of the windshield, for example to provide lighting for the front of a vehicle interior. In some embodiments, there may be multiple light sources 121 positioned around or within the glazing 100 so as to provide light for multiple passengers within a vehicle. For example, a glazing may be a sunroof with two separate lighting systems, including two light sources, one to provide cabin lighting to the front of the vehicle cabin and the other to provide cabin lighting to the back half of the vehicle that may be operated independently. In some other embodiments, the glazing 100 may be part of a back window such that the light emitted from the light extraction zone 123 serves as a brake light.

The glazing 100 of laminated structure having such a lighting system 120 may preferably include clear or light colored layers between a vehicle interior and the light extraction zone 123. Some embodiments may include the use of tinted glass, interlayers, coatings, or films outside of the light extraction zone 123. Where the direct light from the light extraction zone 123 may be too bright, the intensity of the light source 121 may be adjusted. Additionally, a dark layer may be provided between the light extraction zone 123 and the vehicle interior. For example, the second glass sheet 102 may have a dark color. A dark color may include a green color or a grey privacy color. Some embodiments may further include a solar control layer within the interlayer and outside of the light guide 122 and light extraction zone 123. A solar control layer may include, for example, an infrared reflective layer or layers, which may be provided as a coating on a glass surface or film. In some embodiments, the coating may be omitted from an area where the light is dispersed from the laminated glazing 100. Such an omission may be provided, for example, by masking the coated surface during coating or removing the coating in the desired area.

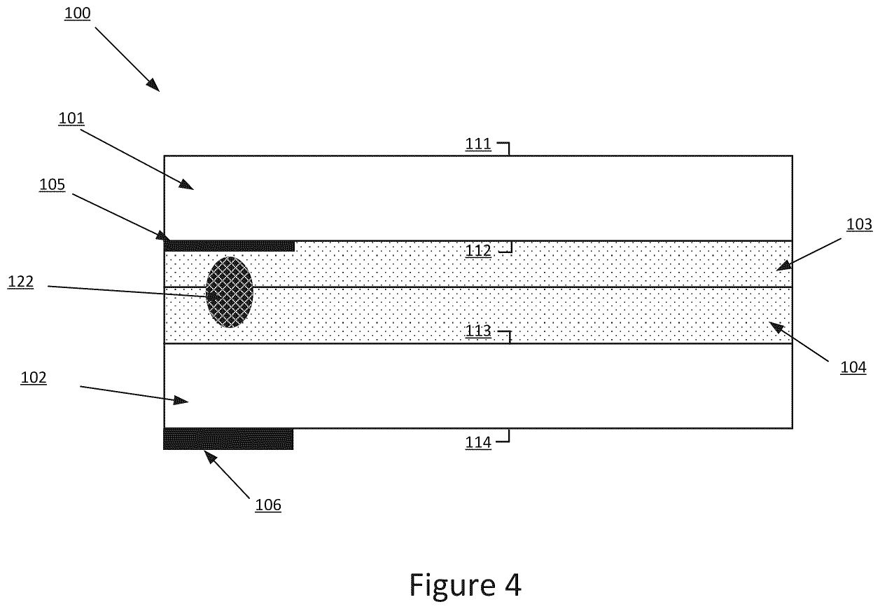

FIG. 4 illustrates a cross section of another example embodiment of a laminated glazing of the present disclosure. A laminated glazing may also include a lens 106 for directing light emitted from the light extraction zone 123 of the light guide 122. For example, the lens 106 may direct light emitted from the light extraction zone 123 to the fourth surface 114 of the second glass sheet 102 such that reading lighting is provided from the light directed by the lens 106 from the surface of a passenger window in a vehicle. The lens 106 may be adhered to the fourth surface 114 of the second glass sheet 102 with an optically suitable adhesive such that the light may be directed from the lens 106. A lens 106 may be any appropriate material, and may include, but is not limited to, a hologram, a Fresnel lens, or a braided index lens. The lens may be large enough to collect the light from the light extraction zone 123. If the light is to be concentrated and made more direct, the lens 106 may be a convex lens. A concave lens may be used to expand light from the light extraction zone 123.

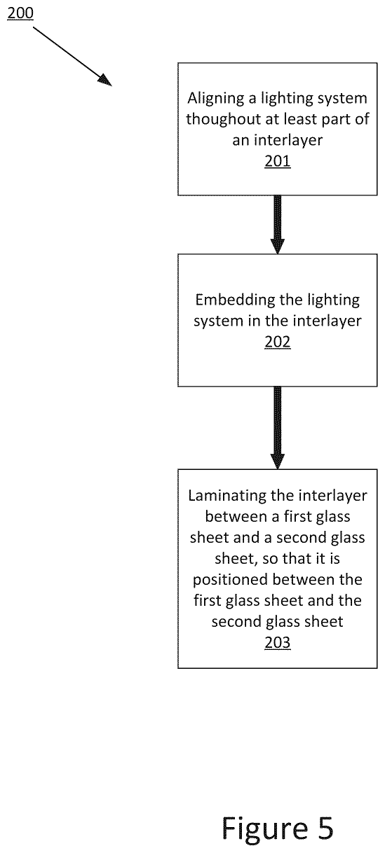

FIG. 5 is a block diagram illustrating a method of preparing a glazing according to the present disclosure. A method 200 of preparing an embodiment of the present disclosure may include aligning a light guide 122, such as an optical fiber light guide, of a lighting system throughout at least part of an interlayer (block 201). For example, a light guide may be aligned along only the base of a rear windshield to provide a brake light to the exterior of a vehicle. The method 200 also may include embedding the lighting system in the interlayer (block 202). The interlayer may contain multiple layers such that the lighting system is embedded in between two layers of the interlayer. The method may also include laminating the interlayer between a first glass sheet and a second glass sheet so that it is positioned between the first glass sheet and the second glass sheet (block 203). The method may also include providing an opaque masking layer to at least part the first or second glass sheet or the interlayer. Additionally, the method may include coupling a lens to at least part of the glass sheet surface facing the interior of the vehicle (i.e. the fourth surface 114). For example, a lens 106 may be attached to the fourth surface 114 of the second glass sheet 102 at the light extraction zone 123 so that the lens 106 may direct the light in a desired manner, such as providing a directed reading light.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A glazing, comprising:
a laminated structure including:
a first glass sheet with a first surface and a second surface;
a second glass sheet with a third surface and a fourth surface;
an interlayer between the first glass sheet and the second glass sheet; and,
a lighting system, including:
a light source;
a light guide attached to the first light source and at least partially laminated between the first glass sheet and the second glass sheet; and
a light extraction zone having a light extraction means laminated between the first glass sheet and the second glass sheet, such that the lighting system provides a directed light for an interior or exterior of a vehicle.

2. The glazing according to claim 1, wherein the interlayer is comprised of at least two separate layers.

3. The glazing according to claim 1, wherein the light guide is embedded into the interlayer.

4. The glazing according to claim 1, wherein a laminated portion of the light guide is positioned substantially along an opaque masking layer.

5. The glazing according to claim 4, wherein the opaque masking layer is an enamel print.

6. The glazing according to claim 1, further comprising at least one additional lighting system.

7. The glazing according to claim 1, wherein the light extraction means includes a luminescent composition.

8. The glazing according to claim 1, wherein the light guide is arranged around the periphery of the glazing.

9. The glazing according to claim 1, wherein the light guide extends out of at least one side the glazing.

10. The glazing according to claim 1, wherein the lighting system further comprises at least one lens positioned at the light extraction zone

11. The glazing according to claim 1, wherein the light source is a laser.

12. The glazing according to claim 1, wherein the light source attaches to the light guide via a fiber optic connector or an optical fiber coupler.

13. The glazing according to claim 1, wherein either the first glass sheet or the second glass sheet is darkened in color.

14. The glazing according to claim 1, further comprising an infrared reflective layer.

15. The glazing according to claim 1, wherein the lighting system provides a reading light for a vehicle interior.

16. The glazing according to claim 1, wherein the lighting system provide a brake light to a vehicle exterior.

17. A method of preparing a glazing comprising:
aligning a lighting system including a light guide and a light extraction zone with a light extraction means throughout at least part of an interlayer;
embedding the aligned lighting system in the interlayer;
laminating the interlayer between a first glass sheet and a second glass sheet such that the interlayer is in between the first glass sheet and second glass sheet.

18. The method of claim 17, wherein the light guide of the lighting system is aligned such that it extends out of the glazing to attach to a light source.

19. The method of claim 17, further comprising providing an opaque masking layer on at least part of the interlayer, the first glass sheet, or the second glass sheet.

20. The method of claim 17, further comprising attaching a lens to the surface of the second glass sheet at the light extraction zone.
